(19) United States
(12) Patent Application Publication
(10) Pub. No.: US 2019/0242715 A1
(43) Pub. Date: Aug. 8, 2019

(54) MOBILE SHOP SYSTEM AND CONTROL METHOD OF MOBILE SHOP SYSTEM

(71) Applicant: Toyota Jidosha Kabushiki Kaisha, Toyota-shi Aichi-ken (JP)

(72) Inventors: Michio Ikeda, Nagoya-shi Aichi-ken (JP); Eiichi Ishii, Nisshin-shi Aichi-ken (JP); Mitsugu Makita, Nagoya-shi Aichi-ken (JP); Toru Yoshida, Miyoshi-shi Aichi-ken (JP); Gaku Itou, Nagoya-shi Aichi-ken (JP)

(21) Appl. No.: 16/268,893

(22) Filed: Feb. 6, 2019

(30) Foreign Application Priority Data
Feb. 7, 2018 (JP) 2018-020261

(51) Int. Cl. G01C 21/34; G05D 1/02; G01C 21/36; G05D 1/00

(52) U.S. Cl. CPC G01C 21/343; G05D 1/0287; G05D 2201/0213; G05D 1/0088; G01C 21/362

(57) ABSTRACT

A mobile shop system including a plurality of mobile shop vehicles and a server device, where the server device includes at least one processor configured to acquire a desired shop which a user wishes to visit among shops carried by the plurality of mobile shop vehicles, and create an operation plan in such a way that the user and a mobile shop vehicle carrying the desired shop are enabled to gather together at a predetermined location, and each of the plurality of mobile shop vehicles, includes at least one processor configured to manage operation of a vehicle according to the operation plan that is received.

### CROSS-REFERENCE TO RELATED APPLICATION

This application claims the benefit of Japanese Patent Application No. 2018-020261, filed on Feb. 7, 2018, which is hereby incorporated by reference herein in its entirety.

### BACKGROUND

### Technical Field

The present disclosure relates to a mobile shop system, including a plurality of mobile shop vehicles, and a control method of the mobile shop system.

### Description of the Related Art

There is a proposal to use vehicles as mobile shops and mobile exhibition venues (Patent document 1). It is conceivable to gather such mobile shop. vehicles in an open space to build a shopping mall.

Such a shopping mall is made up of mobile shop vehicles, and is advantageous in that a layout of shops may be flexibly changed.

### CITATION LIST

### Patent Document

Patent Literature 1: Japanese Patent Laid-Open No. 2010-143558

In a shopping mall made up of a plurality of mobile shop vehicles, when a layout of shops is changed, a user may have difficulty grasping which shop is at which location, and even if the user is able to grasp such information, there may be inconvenience in visiting a plurality of shops.

The present disclosure has been made in view of the problem described above, and has its object to provide a technology that is capable of increasing convenience of a user in a shopping mall made up of a plurality of mobile shop vehicles.

### SUMMARY

A first aspect of the present disclosure is a mobile shop system including a plurality of mobile shop vehicles and a server device. The server device may create an operation plan for the plurality of mobile shop vehicles in such a way that a user and a mobile shop vehicle carrying a shop the user wishes, to visit (i.e., a desired shop) are enabled to gather together at a predetermined location. Each of the plurality of mobile shop vehicles may travel according to the operation plan.

Specifically, the server device may include at least one processor configured to: acquire, from a user who uses the mobile shop system, a visit request including a desired shop which the user wishes to visit among shops carried by the plurality of mobile shop vehicles; acquire position information of the plurality of mobile shop vehicles and the user; create an operation plan for the plurality of mobile shop vehicles in such a way that the user and a mobile shop vehicle carrying the desired shop are enabled to gather together at a predetermined location, based on the visit request and the position information of the plurality of mobile shop vehicles and the user; and transmit the operation plan to the plurality of mobile shop vehicles. Each of the plurality of mobile shop vehicles may include at least one processor configured to: receive the operation plan transmitted by the server device; and manage operation of a vehicle according to the operation plan that is received.

With such a mobile shop system, a layout of shops may be flexibly changed. Position information pieces of a plurality of mobile shop vehicles at this time are acquired by the server device. That the layout of shops may be flexibly changed is advantageous; however, this may cause inconvenience to a user when the user visits a plurality of shops. For example, a change in the layout of shops does not necessarily result in a layout where shops of a certain type (genre) are gathered together, and thus, a user is possibly prevented from efficiently visiting a plurality of shops of the type (genre). For example, a user being an elderly person may be difficult to move to visit the plurality of shops in the first place.

Accordingly, in the mobile shop system described above, the at least one processor of the server device may be configured to acquire, in advance, a desired shop from a user, the desired shop included in a visit request. The at least one processor of the server device may acquire the visit request by, receiving, from the user, information about the shop the user wishes to visit (such as a name, a type, a line of products/services and the like of the shop). The at least one processor of the server device may also provide the user with information about shops arranged in a shopping mall, for example, and acquire a shop selected by the user (i.e., a desired shop) by receiving the visit request. Then, the at least one processor of the server device may create an operation plan for the plurality of mobile shop vehicles in such a way that the user and mobile shop vehicles carrying the desired shops are enabled to gather together at a predetermined-location. The at least one processor of the server device may select a mobile shop vehicle carrying a shop that matches the request from the user, among the plurality of mobile shop vehicles, and create an operation plan in such a way that the user who made the request and the mobile shop vehicle are enabled to gather together.

The operation plan that is created in the above manner may be transmitted by the server device to the plurality of mobile shop vehicles. Then, each of the plurality of mobile shop vehicles may receive the operation plan, and operation of the vehicle is managed according to the received operation plan. The at least one processor of each of the plurality of mobile shop vehicles may manage operation of the vehicle by directly controlling operation of the mobile shop vehicle through autonomous driving, or may manage operation of the vehicle by providing the operation plan to a driver. The mobile shop vehicle carrying the desired shop is thus operated to head toward the predetermined location. Alternatively, the user may be caused to head toward the predetermined location, by using an arbitrary vehicle among the plurality of mobile shop vehicles. The convenience of the user may be thus increased.

The at least one processor of the server device may further acquire a visiting order of the user visiting the desired shops, the visiting order included in the visit request, and may create the operation plan in such a way that mobile shop vehicles carrying the desired shops are lined up at the predetermined location according to the visiting order. In this case, a plurality of mobile shop, vehicles carrying desired shops are all gathered together at the predetermined location. Furthermore, the vehicles are lined up at the predetermined location in the visiting order. The user may thus visit the desired shops in the desired order by sequentially accessing the vehicles that are lined up. The convenience of the user may be thus appropriately increased.

The at least one processor of the server device may create the operation plan in such a way that the mobile shop vehicles carrying the desired shops are gathered at a current position of the user. Because the user himself/herself thereby does not have to move and head toward the predetermined location, the convenience of the user may be appropriately increased.

The at least one processor of the server device may create the operation plan in such a way that an arbitrary mobile shop vehicle among the plurality of mobile shop vehicles is enabled to transport the user to the mobile shop vehicle carrying the desired shop. In this case, although the user himself/herself has to move and head toward the mobile shop vehicle carrying the desired shop (i.e., the predetermined location), the user may head toward the mobile shop vehicle carrying the desired shop by boarding an arbitrary mobile shop vehicle. Accordingly, even in a case where it is difficult for a user to visit the desired shop on foot, for example, the user may visit the desired shop, and the convenience of the user may be thus increased.

Furthermore, the at least one processor of the server device may further acquire a visiting order of the user visiting the desired shops, the visiting order included in the visit request, and may create the operation plan in such a way that the mobile shop vehicle carrying the desired shop that is currently visited by the user is enabled to transport the user to the mobile shop vehicle carrying the desired shop to be visited next by the user. In this case, the user may head toward a desired shop which is planned to be visited next, while shopping in a desired shop, for example. The convenience of the user may be thus appropriately increased.

In the mobile shop system described above, the at least one processor of the server device may acquire the visit request from a mobile terminal of the user. In this case, the mobile shop system according to the present disclosure may include the plurality of mobile shop vehicles, the server device, and a mobile terminal of the user (i.e., a user terminal).

The plurality of mobile shop vehicles may be autonomous mobile bodies configured to move autonomously according to the operation plan. In this case, a layout of shops may be automatically changed. At this time, at the time of the at least one processor of the mobile shop vehicle managing operation of the mobile shop vehicle, the at least one processor may directly control operation of the mobile shop vehicle through autonomous driving.

Another aspect of the present disclosure is a control method of a mobile shop system including a plurality of mobile shop vehicles and a server device. The control method according to the present aspect may include acquiring, by the server device, from a user who uses the mobile shop system, a visit request including a desired shop which the user wishes to visit, among shops carried by the plurality of mobile shop vehicles; acquiring, by the server device, position information of the plurality of mobile shop vehicles and the user; creating, by the server device, an operation plan for the plurality of mobile shop vehicles in such away that the user and a mobile shop vehicle carrying the desired shop are enabled to gather together at a predetermined location based on the visit request and the position information of the plurality of mobile shop vehicles and the user; transmitting, by the server device, the operation plan, to the plurality of mobile shop vehicles; receiving, by each of the plurality of mobile shop vehicles, the operation plan transmitted by the server device; and managing, by the each of the plurality of mobile shop vehicles, operation of a vehicle according to the operation plan that is received.

The present disclosure may be specified as a mobile shop system including at least one of the processing described above. The present disclosure may also be specified as a program for causing a computer to perform the control method described above, or a non-transitory computer-readable medium storing the program. The processes described above may be freely combined to the extent that no technical conflict exists.

According to the present disclosure, convenience of a user may be increased in a shopping mall made up of a plurality of mobile shop vehicles.

### BRIEF DESCRIPTION OF THE DRAWINGS

FIG. 1 is a system overview of a mobile shop system according to a first embodiment;

FIG. 2 is a functional block diagram of the mobile shop system according to the first embodiment;

FIG. 3 is a diagram illustrating an example of a shop information list screen on a user terminal, provided by a server device;

FIG. 4 is a diagram illustrating an example of a request screen on the user terminal;

FIG. 5 is a diagram illustrating an example of a visit request registration screen on the user terminal;

FIG. 6 is a diagram describing a flow of a process of the mobile shop system according to the first embodiment;

FIG. 7A is a first diagram for describing a mode of gathering together of mobile shop vehicles according to the first embodiment;

FIG. 7B is a second diagram for describing the mode of gathering together of the mobile shop vehicles according to the first embodiment;

FIG. 8 is a system overview of a mobile shop system according to a second embodiment;

FIG. 9 is a functional block diagram of the mobile shop system according to the second embodiment;

FIG. 10A is a first diagram for describing a mode of gathering together of a user and mobile shop vehicles according to a, third embodiment;

FIG. 10B is a second diagram for describing the mode of gathering together of a user and the mobile shop vehicles according to the third embodiment;

FIG. 10C is a third diagram for describing the mode of gathering together of a user and the mobile shop vehicles according to the third embodiment; and

FIG. 10D is a fourth diagram for describing the mode of gathering together of a user and the mobile shop vehicles according to the third embodiment.

### DESCRIPTION OF THE EMBODIMENTS

### First Embodiment

### (System Overview)

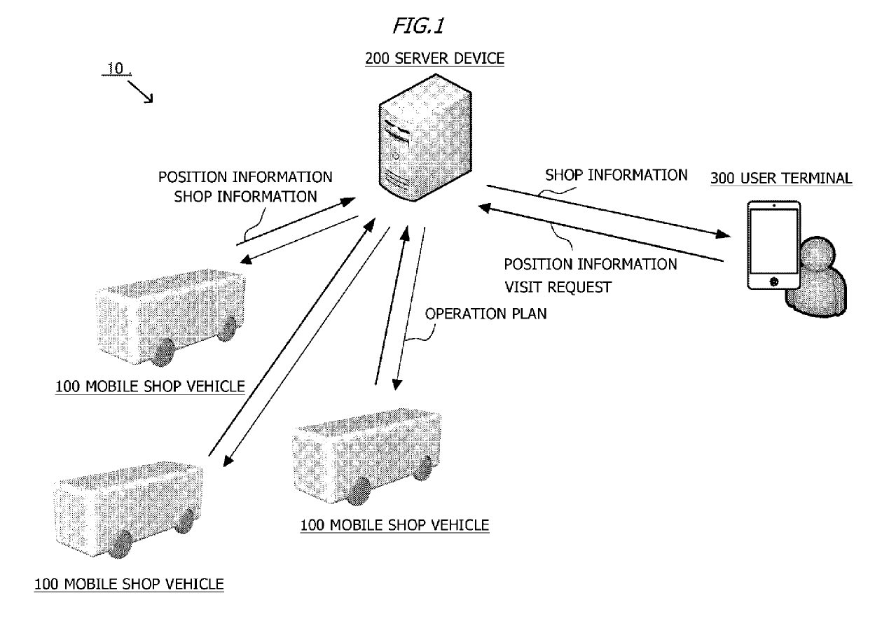

A present embodiment is a mobile shop system in a shopping mall (shopping complex) formed by a plurality of mobile shop vehicles which are gathered together. In the following, a mobile shop system 10 according to the present embodiment will be described with reference to FIG. 1. The mobile shop system 10 according to the present embodiment includes a plurality of mobile shop vehicles 100, a server device 200, and a user terminal 300.

The mobile shop vehicles 100 are multipurpose mobile bodies which are each capable of having a function different from that of another, and are, in the present embodiment, vehicles which are capable of traveling on a road. The mobile shop vehicle 100 includes, inside the vehicle, facility/equipment for operating a shop, and may operate a business by traveling to a destination and spreading out the facility/equipment. In the present disclosure, a “shop” refers to a facility for providing products (objects) or services for profit or for free.

The present embodiment assumes that the plurality of mobile shop vehicles 100 gather together in an open space to function as a shopping mall. Because a shopping mall according to the present embodiment is formed by the mobile shop vehicles 100 gathering together, the shopping mall may be easily set up in a place or a region where there are no shops.

A shopping mall made up of the mobile shop vehicles 100 is characteristic in that a layout of the mobile shop vehicles 100 can be easily changed. Accordingly, the layout of the mobile shop vehicles 100 in the shopping mall may be switched, or mobile shop vehicles 100 to be opened may be changed according to dates and time slots.

The server device 200 is capable of providing the user terminal 300 possessed by a user with shop information transmitted from the mobile shop vehicles 100. The user may then view the shop information on the user terminal 300, and grasp shops that are arranged in the shopping mall.

However, even if information of shops that are arranged in a shopping mall is provided to a user in this manner, it may be inconvenient for the user to actually visit the shops. For example, if the user is an elderly person, the user himself/herself moving and visiting shops may be difficult in the first place. Accordingly, the mobile shop system 10 according to the present embodiment allows a user and a mobile shop vehicle 100 carrying a shop the user wishes to visit (i.e., a desired shop) to gather together at a predetermined location.

Specifically, the server device 200 acquires, from a user, position information of the user and a visit request. A user may transmit these information pieces to the server device 200 by using the user terminal 300. Additionally, the visit request includes information about the desired shop. Details will be given later. Then, the server device 200 creates an operation plan for the mobile shop vehicles 100 based on received position information of the mobile shop vehicles 100, the shop information, the received position information of the user and the visit request, in such a way that the user and the mobile shop vehicles 100 carrying the desired shops may gather together at a predetermined location, and transmits the operation plan to each mobile shop vehicle 100. Then, each mobile shop vehicle 100 is operated according to the operation plan.

### (System Configuration)

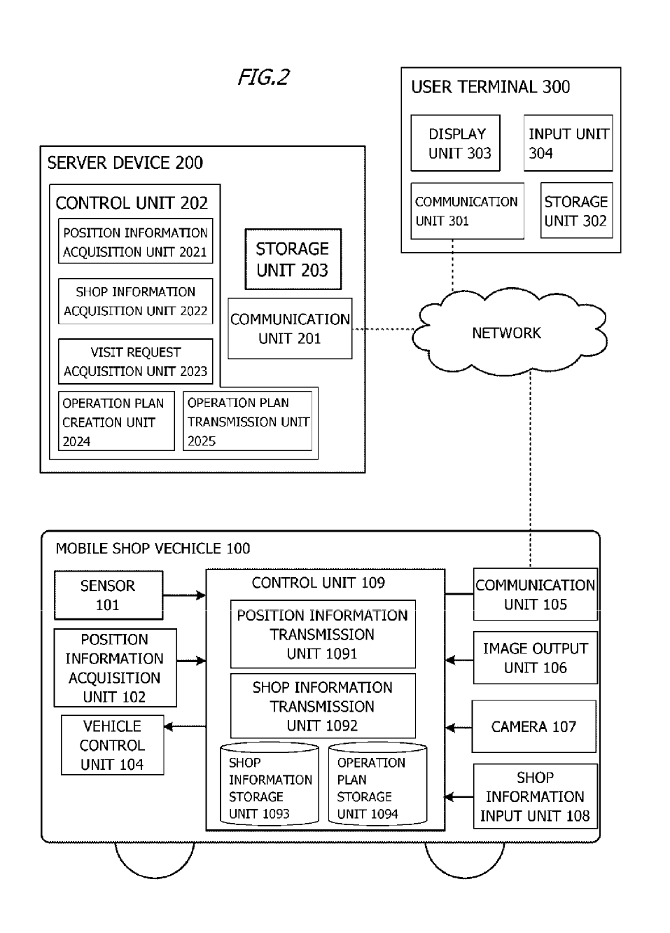

Constituent elements of the system will be described in detail. FIG. 2 is a block diagram schematically illustrating an example configuration of the mobile shop vehicle 100, the server device 200, and the user terminal 300 illustrated in FIG. 1.

### (Mobile Shop Vehicle 100)

The mobile shop vehicle 100 includes, inside the vehicle, equipment for operating a shop, but in the present specification, a description of the equipment for operating a shop is omitted. A description is given here mainly of a function of a vehicle, which is common for the plurality of mobile shop vehicles 100.

The mobile shop vehicle 100 includes a sensor 101, a position information acquisition unit 102, a vehicle control unit 104, a communication unit 105, an image output unit 106, a camera 107, a shop information input unit 108, and a control unit 109. The mobile shop vehicle 100 may be a gasoline vehicle, a diesel vehicle or an electric vehicle, and is driven by an internal-combustion engine or by power supplied from a battery.

The sensor 101 senses a state of the vehicle, or that senses the surroundings of the vehicle. As the sensor 101 for sensing the state of the vehicle, an accelerometer, a speed sensor or an azimuth sensor may be cited. As the sensor 101 for sensing the surroundings of the vehicle, a stereo camera, a laser scanner, a LIDAR, a radar or the like may be cited. Information acquired by the sensor 101 is transmitted to the control unit 109.

The position information acquisition unit 102 acquires a current position of the vehicle, and is typically a global positioning system (GPS) device that receives a GPS satellite signal and that obtains position information. The position information obtained from the GPS device indicates latitude, longitude and altitude. The position information acquisition unit 102 may be a positioning device according to a global navigation satellite system (GNSS) instead of the GPS, or a positioning device adopting base station positioning, so long as the current position of the vehicle may be acquired.

The vehicle control unit 104 controls functions, of the mobile shop vehicle 100, as the vehicle. For example, the vehicle control unit 104 includes an engine or a motor and an inverter, a brake, steering, and an electronic control unit (ECU) that controls these parts.

The communication unit 105 connects the mobile shop vehicle 100 to a network. In the present embodiment, communication with other devices (such as the server device 200) may be performed over the network by using a mobile communication service such as 3G or LTE. Additionally, the communication unit 105 may also include communication units for performing inter-vehicle communication with other mobile shop vehicles 100.

The image output unit 106 outputs an image to an outside display provided on the vehicle body. The mobile shop vehicle 100 according to the present embodiment includes a display on the outside of the vehicle body, and is capable of outputting an arbitrary image. The outside display may be a liquid crystal display, an organic EL display, or an LED matrix, for example.

The camera 107 is a camera provided on the vehicle body of the mobile shop vehicle 100. In the present embodiment, the mobile shop vehicle 100 includes a camera 107 mounted on the vehicle 100, and is capable of acquiring an image (still image or moving image). The number of cameras 107 is not particularly specified as long as it is at least one. A plurality of cameras may be installed such that capturing may be performed with respect to the front, rear, left and right.

The shop information input unit 108 is used to input information of the mobile shop vehicle 100 as a shop. As the shop information, a name of the shop, a type (genre), an exterior appearance, contact details, opening hours, a line of products/services, product stock information, sales price information, bargain price information, opening hours information, and a size of the vehicle (shop) may be cited. One or a plurality of items mentioned above are input to the shop information input unit 108. The shop information may include an identifier (ID) for identifying the shop. The shop identifier may be the same as a vehicle identifier, or may be associated with the vehicle identifier.

The control unit 109 is a computer that controls the entire mobile shop vehicle 100. For example, the control unit 109 includes a microprocessor and a memory storing programs, and functions as a position information transmission unit 1091, a shop information transmission unit 1092, a shop information storage unit 1093, and an operation plan storage unit 1094, when the microprocessor executes the programs. Additionally, a part or all of the functions may be achieved by a logic circuit such as an application specific integrated circuit (ASIC). or a field programmable gate array (FPGA).

The position information transmission unit 1091 transmits the position information that is acquired from the position information acquisition unit 102 to the server device 200 through the communication unit 105. The position information transmission unit 1091 may transmit the position information at an arbitrary timing, and transmission may be performed regularly or at a timing of transmission of the shop information, for example.

The shop information transmission unit 1092 transmits the shop information that is stored in the shop information storage unit 1093 to the server device 200 through the communication unit 105. The shop information transmission unit 1092 may transmit the shop information at an arbitrary timing, and transmission may be performed regularly, for example.

The position information and, the shop information are transmitted in association with the shop identifier. The position information and the shop information may be transmitted to the server device 200 as separate messages, or may be transmitted to the server device 200 as one message. In the case where the shop information and the position information are transmitted as separate messages, these messages do not have to be transmitted to the server device 200 through a same communication path, and may be transmitted through any communication path as long as the messages finally reach the server device 200.

Information of the mobile shop vehicle 100 as a shop is stored in the shop information storage unit 1093. As some examples of the shop information, a name of the shop, a type (genre), an exterior appearance, contact details, opening hours, a line of products/services, product stock information, sales price information, bargain price information, opening hours information, and a size of the vehicle (shop) may be cited. The shop information may include an identifier (ID) for identifying the shop.

An operation plan for the mobile shop vehicle 100 is stored in the operation plan storage unit 1094. As described later, the operation plan is created by the server device 200. The mobile shop vehicle 100 receives the operation plan through the communication unit 105, and the received operation plan is stored in the operation plan storage unit 1094.

The mobile shop vehicle 100 according to the present embodiment is an autonomous vehicle allowing autonomous or driverless driving, and is driven according to the operation plan. Specifically, the mobile shop vehicle 100 autonomously travels when the vehicle control unit 104 is controlled according to the operation plan. Additionally, the mobile shop vehicle 100 is not intended to be limited to an autonomous vehicle, and the mobile shop vehicle 100 may be driven by a driver instead. In this case, the driver may perform operation of the mobile shop vehicle 100 according to the operation plan that is stored in the operation plan storage unit 1094. For example, navigation according to the operation plan is provided to the driver.

### (Server Device 200)

Next, the server device 200 will be described. The server device 200 acquires the position information and the shop information from the plurality of mobile shop vehicles 100. Furthermore, the position information of the user and the visit request are acquired from the user terminal 300. Then, an operation plan is created and transmitted to the plurality of mobile shop vehicles 100.

The server device 200 includes a communication unit 201, a control unit 202, and a storage unit 203.

Like the communication unit 105, the communication unit 201 is a communication interface for performing communication with the mobile shop vehicle 100 and the user terminal 300 over the network.

The control unit 202 is in charge of control of the server device 200. For example, the control unit 202 includes a microprocessor and a memory storing programs, and functions as a position information acquisition unit 2021, a shop information acquisition unit 2022, a visit request acquisition unit 2023, an operation plan creation unit 2024 and an operation plan transmission unit 2025, when the microprocessor executes the programs. Additionally, a part or all of the functions may be achieved by a logic circuit such as an ASIC or an FPGA.

The position information acquisition unit 2021 acquires the position information that is transmitted by the position information transmission unit 1091 of the mobile shop vehicle 100. The position information of the user terminal 300 is also acquired. The position information of the mobile shop vehicle 100 that is acquired by the position information acquisition unit 2021 is stored in the storage unit 203 in association with the shop identifier. The position information of the user terminal 300 that is acquired by the position information acquisition unit 2021 is stored in the storage unit 203 in association with an identifier for identifying the user (i.e., a user identifier). Additionally, the user identifier is acquired together with the position information of the User terminal 300.

The shop information acquisition unit 2022 acquires the shop information that is transmitted by the shop information transmission unit 1092 of the mobile shop vehicle 100. The shop information that is acquired by the shop information acquisition unit 2022 is stored in the storage unit 203 in association with the shop identifier. The shop information is transmitted to the user terminal 300 through the communication unit 201.

The visit request acquisition unit 2023 acquires a visit request that is transmitted from the user terminal 300. The visit request that is acquired by the visit request acquisition unit 2023 is stored in the storage unit 203 in association with the user identifier. The visit request acquisition unit 2023 may acquire, as the visit request, a shop selected by the user (i.e., a desired shop), among shop information pieces acquired by the shop information acquisition unit 2022 arid transmitted to the user terminal 300. Alternatively, the visit request acquisition unit 2023 may acquire the visit request by receiving, from the user, information about a shop the user wishes to visit. A request input operation that is performed by the user will be described later.

The operation plan creation unit 2024 creates an operation plan for a plurality of mobile shop vehicles 100 based on the position information of the plurality of mobile shop vehicles 100 and the position information of the user terminal 300 that are stored in the storage unit 203 and the visit request that is stored in the storage unit 203. As described above, the operation plan creation unit 2024 creates an operation plan in such a way that the user and the mobile shop vehicle 100 carrying the desired shop may gather together at a predetermined location. Additionally, a mode of gathering together of the mobile shop vehicles 100 according to the present embodiment will be described later.

The operation plan transmission unit 2025 transmits the operation plan that is created by the operation plan creation unit 2024 to the mobile shop vehicle 100 through the communication unit 201.

The storage unit 203 stores information, and is a storage medium such as a RAM, a magnetic disk, a semiconductor memory or the like.

### [User Terminal 300]

The user terminal 300 is a mobile terminal (mobile computer) that is possessed by the user, such as a smartphone terminal or a wearable computer. The user terminal 300 may alternatively be a personal computer (PC) that is connected to the server device 200 through a network, such as the Internet, which is a public communication network.

The user terminal 300 includes a communication unit 301, a storage unit 302, a display unit 303, and an input unit 304.

Like the communication unit 105, the communication unit 301 is a communication interface for performing communication with the server device 200 over the network. The storage unit 302 stores information, and is a storage medium such as a RAM, a magnetic disk, or a semiconductor memory or the like. The display unit 303 is a liquid crystal display (LCD), or an electroluminescence (EL) panel, for example. The input unit 304 includes a touch panel, push buttons, or the like. The input unit 304 may also include an input unit for videos and images, such as a camera, or an input unit for audio, such as a microphone.

The user may input the visit request by using an application, installed in the user terminal 300, for using a service of the mobile shop system 10 (hereinafter also referred to. as a predetermined application). Additionally, user information is registered in advance by the predetermined application.

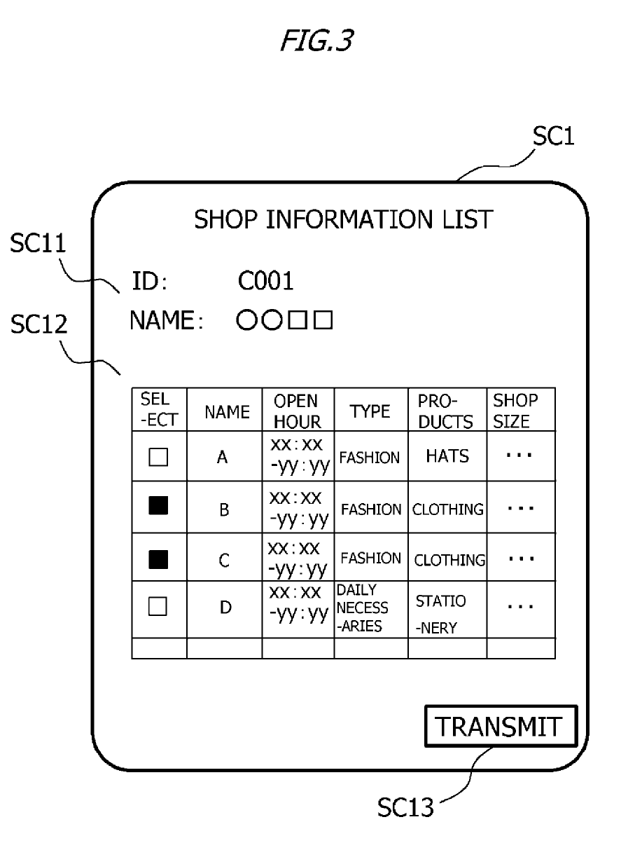

FIG. 3 is a diagram illustrating an example of a shop information list screen provided by the server device 200. A user may input a visit request by selecting a shop the user wishes to visit (i.e., a desired shop) from the shop information list.

A shop information list screen SC1 illustrated in FIG. 3 is provided by the predetermined application. User information SC11 (ID, name), a shop information list SC12, and a registration button SC13 labeled “TRANSMIT” are displayed on the shop information list screen SC1.

The shop information list SC12 includes fields of a shop name, opening hours, a type (genre), a line of products (services), and a shop size. A check box for selecting a shop the user wishes to visit (i.e., a desired shop) is used for SELECT. A visit request registration is performed for a checked shop.

The registration button SC13 is an operation button for transitioning to a visit request registration screen for performing a visit request registration, for a shop selected from the shop information list SC12. When the registration button SC13 is pressed, the screen on the user terminal 300 transitions to the visit request registration screen.

Additionally, the user may further input a desired visiting time and a visiting order by using the predetermined application.

The user may input a request regarding a use location, a desired visiting time, a type (genre), a line of products and the like by using the predetermined application, instead of selecting a desired shop from the shop information list.

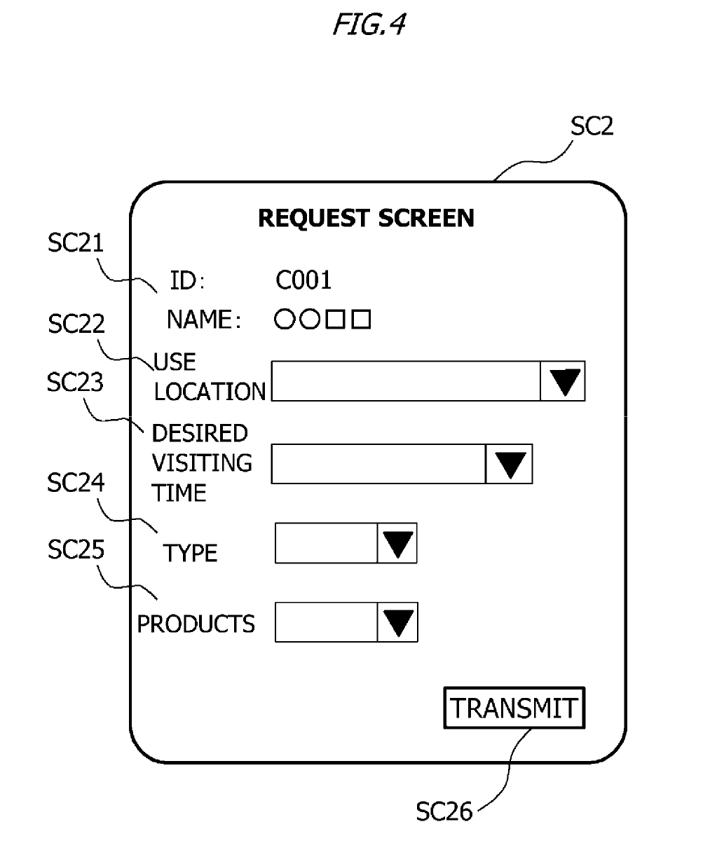

FIG. 4 is a diagram illustrating an example of a request screen. A request screen SC2 is a screen used by a user to register a request. User information SC21 (ID, name), a use location SC22, a desired visiting time SC23, a type (genre) SC24, a line of products (services) SC25, and a registration button SC26 labeled “TRANSMIT” are displayed on the request screen SC2.

The use location SC22 is a location where a desired shop is to be used. A user may designate a current position of the user or a predetermined location. The desired visiting time SC23 is a time when the user wishes to visit the shop. The type SC24 is the type (genre) of the shop the user wishes to visit. The line of products SC25 is the line of products (services) of the shop the user wishes to visit. These input items may be directly input, or may be selected by pull-down, as illustrated in FIG. 4.

As described later in relation to a mode of gathering together of the mobile shop vehicles 100, in the present embodiment, the mobile shop vehicles 100 carrying desired shops may be gathered together at the current position of the user. However, such a case is not restrictive, and in the case where the user selects a location other than the current position in the use location SC22 by pull-down, a candidate for a gathering location of the user and the mobile shop vehicles 100 carrying the desired shops may be provided by the server device 200, for example.

As described above, when a visit request is transmitted from the shop information list screen SC1 illustrated in FIG. 3 or the request screen SC2 illustrated in FIG. 4, the screen on the user terminal 300 transitions to the visit request registration screen.

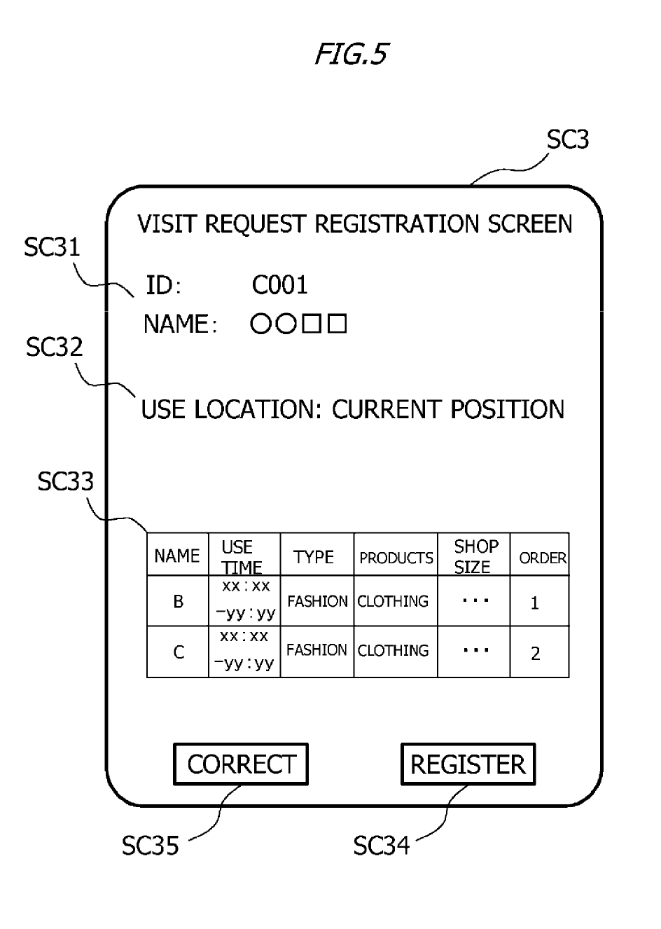

FIG. 5 is a diagram illustrating an example of the visit request registration screen. A visit request registration screen SC3 is provided by the predetermined application. User information SC31 (ID, name), a use location SC32, a desired shop list SC33, a registration button SC34 labeled “REGISTER”, and a correction button SC35 labeled “CORRECT” are displayed on the visit request registration screen SC3. When the registration button SC34 is pressed, a visit request is registered with the server device 200. That is, the visit request acquisition unit 2023 of the server device 200 acquires the visit request, and the visit request is stored in the storage unit 203 in association with the user identifier.

### (Processes)

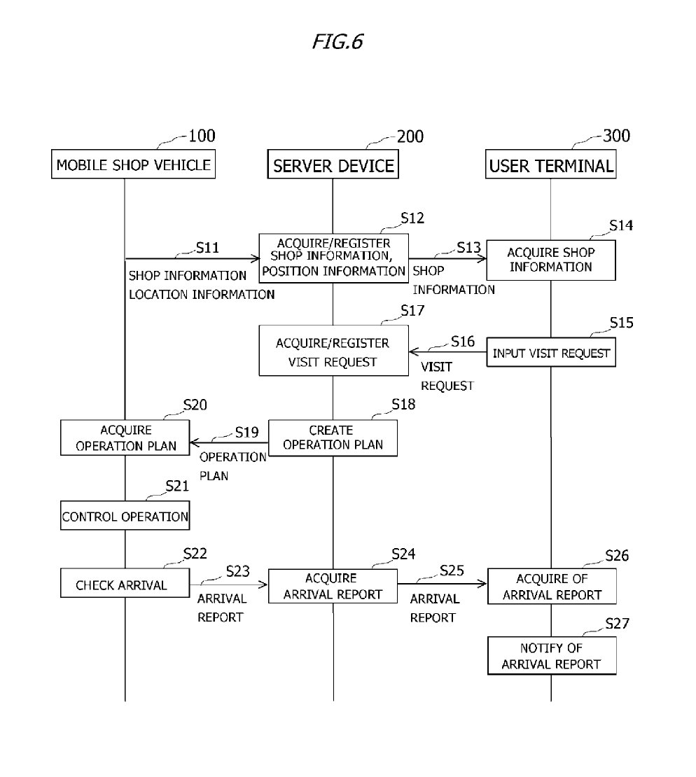

Next, processes performed by the constituent elements described above will be described. FIG. 6 is a flowchart illustrating a flow of a process of gathering the mobile shop vehicles 100 carrying desired shops at the current position of the user. The process indicated by the flowchart in FIG. 6 is merely an example of implementation, and a user and the mobile shop vehicles 100 carrying desired shops may be gathered together by a process different from the process described below.

First, in S11, the shop information transmission unit 1092 of the mobile shop vehicle 100 transmits the shop information that is stored in the shop information storage unit 1093 to the server device 200 through the communication unit 105. The position information transmission unit 1091 of the mobile shop vehicle 100 transmits the position information that is acquired from the position information acquisition unit 102 to the server device 200 through the communication unit 105. Then, in S12, the shop information acquisition unit 2022 of the server device 200 acquires the shop information, and the position information acquisition unit 2021 acquires the position information.

Next, in S13, the shop information that is acquired by the shop information acquisition unit 2022 is transmitted to the user terminal 300. The user terminal 300 acquires the shop information in S14. When the shop information is acquired, the user terminal 300 is enabled to display the shop information list as illustrated in FIG. 3 on the display unit 303. Then, in S15, the user inputs a visit request through the user terminal 300. The visit request input operation by the user is as described above.

The visit request that is input by the user is transmitted to the server device 200 (S16). In S17, the visit request acquisition unit 2023 of the server device 200 acquires the visit request and the visit request that is acquired by the visit request acquisition unit 2023 is stored in the storage unit 203 in association with the user identifier.

Next, in S18, the server device 200 creates an operation plan. Specifically, the operation plan creation unit 2024 of the server device 200 creates an operation plan for a plurality of mobile shop vehicles 100 based on the position information of the plurality of mobile shop vehicles 100 and the position information of the user terminal 300 that are stored in the storage unit 203 and the visit request that is stored in the storage unit 203. In the present embodiment, the operation plan is created in such a way that the mobile shop vehicle 100 carrying the desired shop is gathered at the current position of the user. The operation plan creation unit 2024 selects the mobile shop vehicle 100 carrying the desired shop among the plurality of mobile shop vehicles 100. An operation plan is created for the selected mobile shop vehicle 100 based on the position information of the mobile shop vehicle 100 in question and the current position of the user, in such a way that the mobile shop vehicle 100 in question heads toward the current position of the user. With respect to a mobile shop vehicle 100, among the plurality of mobile shop vehicles 100, not carrying the desired shop, a plan according to which the mobile shop vehicle 100 does not head toward the current position of the user (for example, according to which the mobile shop vehicle 100 does not move from the current position) may be created as the operation plan.

Then, the operation plan that is created by the server device 200 is transmitted to the mobile shop vehicle 100 (S19), and the mobile shop vehicle 100 acquires the operation plan in S20. Then, operation of the mobile shop vehicle 100 is controlled according to the acquired operation plan (S21). Specifically, the vehicle control unit 104 is controlled according to the operation plan, and the mobile shop vehicle 100 thereby autonomously travels to the current position of the user. When the operation control is ended, the mobile shop vehicle 100 performs arrival check based on the current position of the vehicle that is acquired by the position information acquisition unit 102 (S22). Then, an arrival report is issued to the server device 200 (S23).

The server device 200 acquires the arrival report in S24, and transmits the arrival report to the user terminal 300 in S25. Then, after acquiring the arrival report (S26), the user terminal 300 notifies the user of the arrival report (S27).

### (Mode of Gathering Together of Mobile Shop Vehicles)

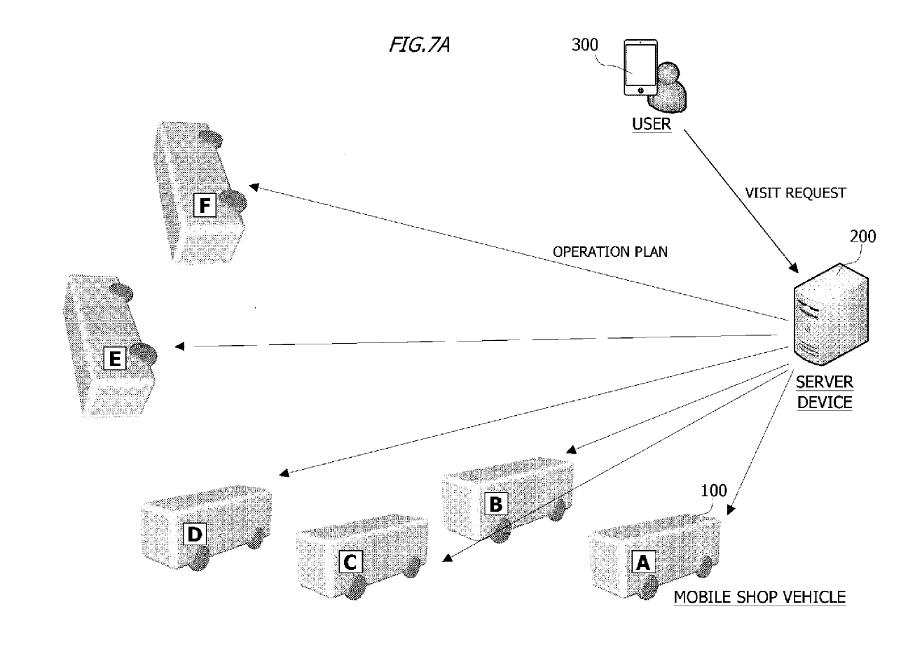

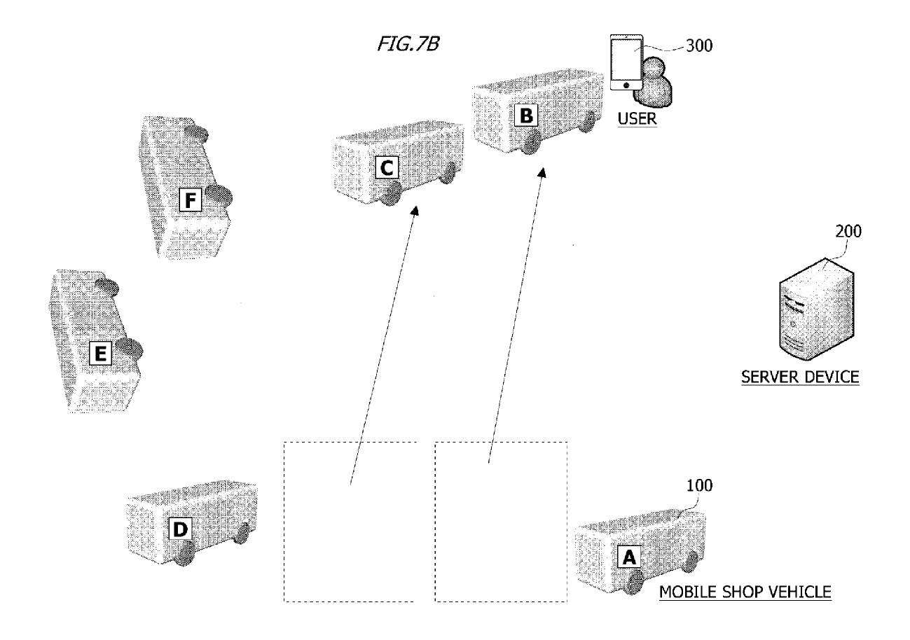

Next, a mode of gathering together of the mobile shop vehicles 100 at the time of execution of the process illustrated in FIG. 6 will be described. FIGS. 7A and 7B are diagrams for describing a mode of gathering together of the mobile shop vehicles 100.

As illustrated in FIG. 7A, in a present example, a shopping mall is made up of six mobile shop vehicles 100. In the following description, shops included in the six mobile shop vehicles 100 will be referred to as shops A-F.

When a user inputs a visit request through the user terminal 300, the server device 200 acquires the visit request. Then, the server device 200 creates an operation plan, and transmits the created operation plan to each of the mobile shop vehicles 100 carrying the shops A-F. In the present example, the shops B and, C are selected by the user as the desired shops.

Then, as illustrated in FIG. 7B, the mobile shop vehicle 100 carrying the shop B and the mobile shop vehicle 100 carrying the shop C are gathered together at the current position of the user. At this time, an operation plan is transmitted to the mobile shop vehicles 100 carrying the shop A and the shops D-F such that these mobile shop vehicles 100 do not move from their current positions, and these mobile shop vehicles 100 are not moved.

According to the mode of gathering together described above, the mobile shop vehicles 100 carrying the desired shops are gathered together at the current position of the user, and thus, the user may efficiently visit shops the user wishes to visit. Even in a case where it is difficult for the user himself/herself to move and visit a plurality of shops, the user may visit the desired shops. That is, the convenience of the user may be increased.

Furthermore, in the present example, there is a request from the user to visit the desired shops in the order of the shop B and the shop C. Accordingly, the mobile shop vehicle 100 carrying the shop B and the mobile shop vehicle 100 carrying the shop C are lined up at the current position of the user in such a visiting order. Then, the user may visit the desired shops in the desired order by accessing the lined-up mobile shop vehicles 100 in order. The convenience of the user may be thus appropriately increased.

In the present embodiment, a mode of gathering the mobile shop vehicles 100 carrying desired shops at the current position of the user is described as an example, but such a case is not restrictive, and it is enough if the user and the mobile shop vehicles 100 carrying the desired shops may be gathered together at a predetermined location. In this case, the user may designate the use location (the predetermined location for gathering together with the mobile shop vehicles 100 carrying the desired shops) on the request screen illustrated in FIG. 4, for example. The user may thus efficiently visit the shops the user wishes to visit, and the convenience of the user is thus increased.

### Second Embodiment

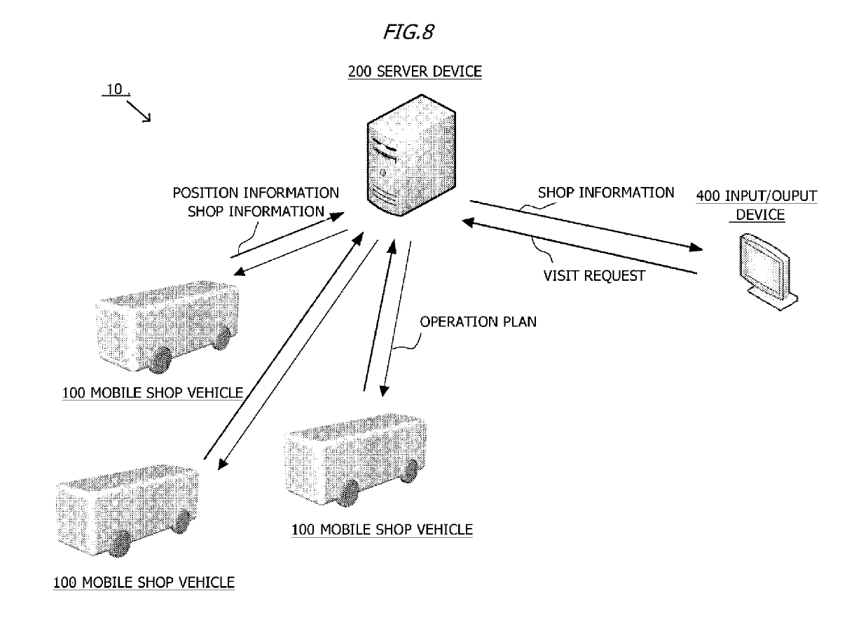

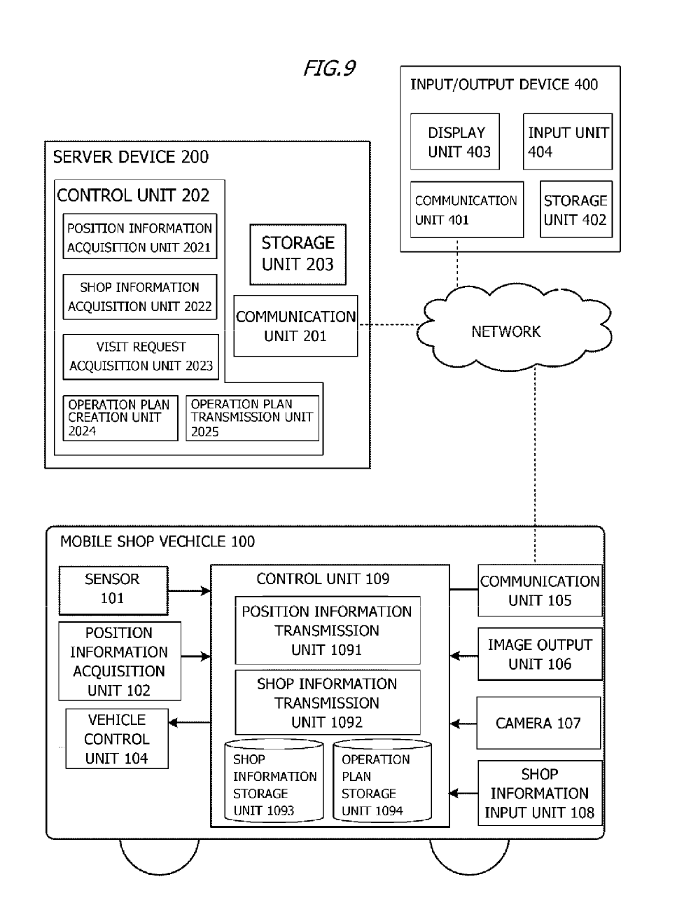

In the first embodiment, the mobile shop system 10 includes a plurality of mobile shop vehicles 100, the server device 200, and the user terminal 300. In contrast, in a present embodiment, the mobile shop system 10 includes a plurality of mobile shop vehicles 100, the server device 200, and an input/output device 400. In the following, the mobile shop system 10 according to the present embodiment will be described with reference to FIGS. 8 and 9.

The input/output device 400 is installed at the shopping mall which is made up of the mobile shop vehicles 100, and as will be described later, the input/output device 400 functions in the same manner as the. user terminal 300 described in the first embodiment. As illustrated in FIG. 8, shop information is provided by the server device 200 to the input/output device 400, and a user is enabled to transmit a visit request to the server device 200 by using the input/output device 400.

As illustrated in FIG. 9, the input/output device 400 includes a communication unit 401, a storage unit 402, a display unit 403, and an input unit 404.

Like the communication unit 105, the communication unit 401 is a communication interface for performing communication with the server device 200 over the network. The storage unit 402 stores information, and is a storage medium such as a RAM, a magnetic disk, or a semiconductor memory or the like. The display unit 403 is a liquid crystal display (LCD), or an electroluminescence (EL) panel, for example. The input unit 404 includes a touch panel, push buttons, or the like. The input unit 404 may also include an input unit for videos and images, such as a camera, or an input unit for audio, such as a microphone.

A user may input a visit request by the same operation as the operation described in the first embodiment, by using the predetermined application that is installed in the input/output, device 400.

For example, at the time of designating a use location on the request screen illustrated in FIG. 4, the user may designate the current position where the input/output device 400 is installed, or may designate an arbitrary position.

Also with the mobile shop system 10 described above, the user may efficiently visit shops the user wishes to visit, and the convenience of the user is thus increased.

### Third Embodiment

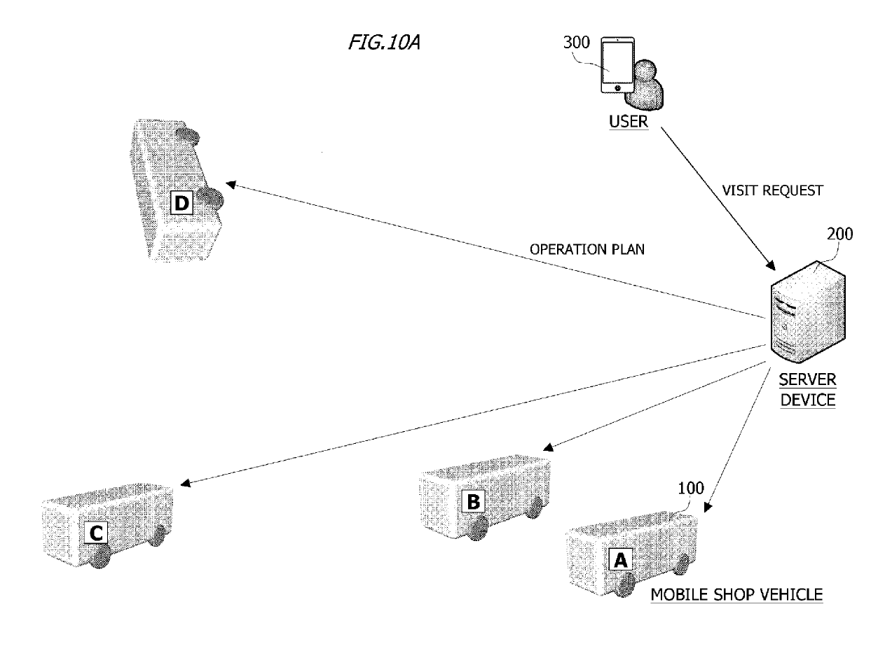

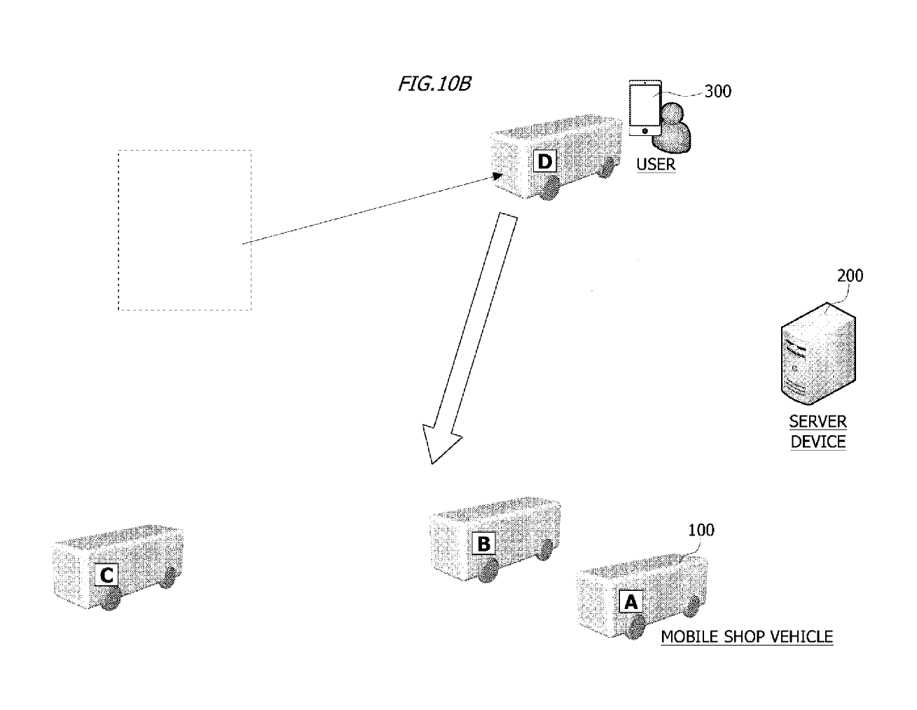

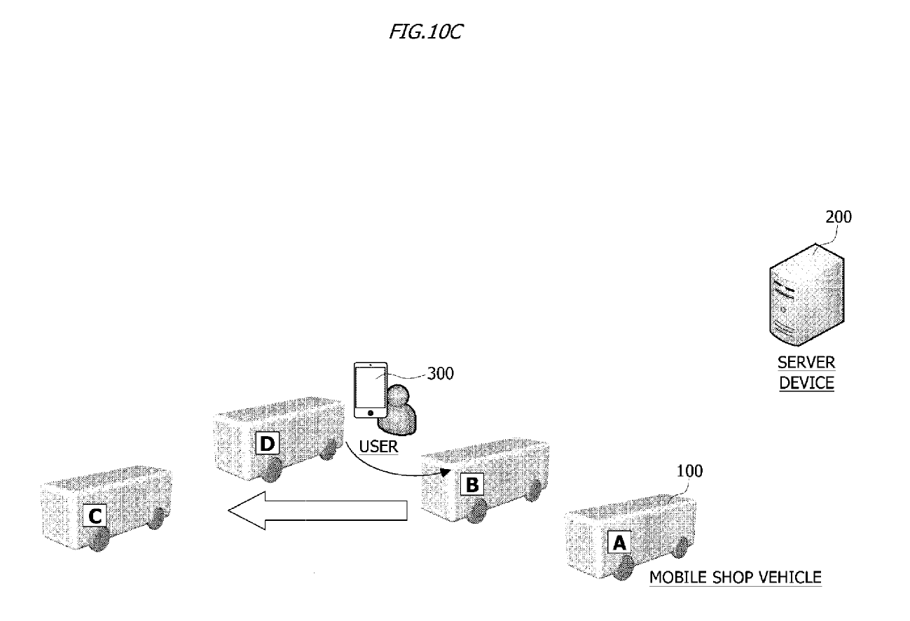

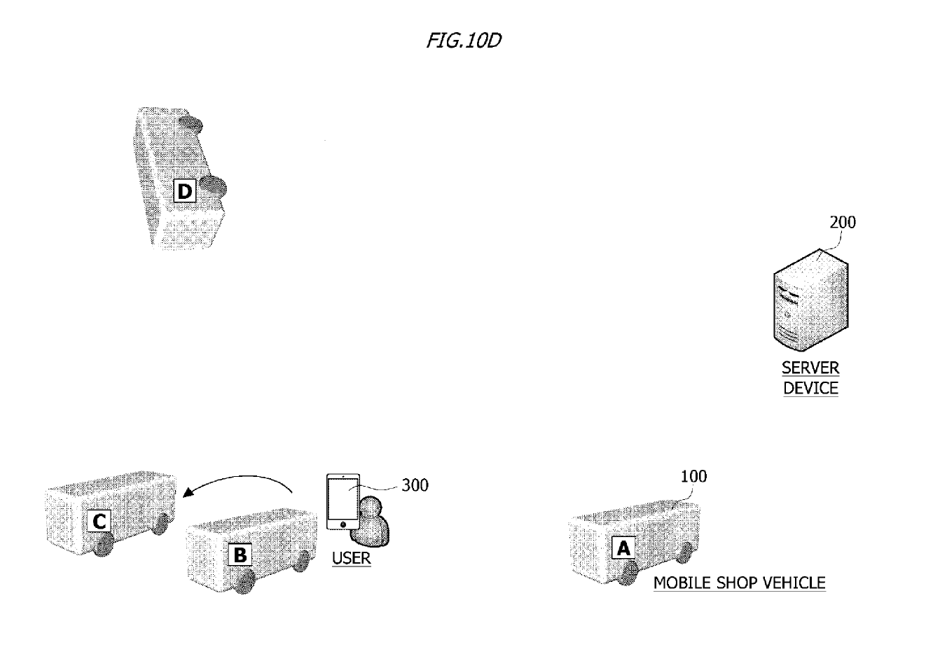

Next, a third embodiment of the present disclosure will be described with reference to FIGS. 10A to 10D. Additionally, in the present embodiment, a detailed description of components and control processes substantially the same as those of the first embodiment is omitted.

In the first embodiment described above, the operation plan creation unit 2024 of the server device 200 creates an operation plan according to which mobile shop vehicles 100 carrying desired shops are gathered together at the current position of the user. In contrast, in the present embodiment, the operation plan creation unit 2024 creates an operation plan according to which an arbitrary mobile shop vehicle 100 among a plurality of mobile shop vehicles 100 is enabled to transport the user to a mobile shop vehicle 100 carrying a desired shop.

FIGS. 10A to 10D are diagrams for describing a mode of gathering together of a user and the mobile shop vehicles 100 carrying desired shops, according to the present embodiment.

As illustrated in FIG. 10A, in a present example, a shopping mall is made up of four mobile shop vehicles 100. In the following description, shops included in the four mobile shop vehicles 100 will be referred to as shops A-D.

When a user inputs a visit request through the user terminal 300, the server device 200 acquires the visit request. Then, the server device 200 creates an operation plan, and transmits the created operation plan to each of the mobile shop vehicles 100 carrying the shops A-D. In the present example, the shops B and C are selected by the user as the desired shops. There is also a request from the user to visit the desired shops in the order of the shop B and the shop C.

Then, as illustrated in FIG. 10B, first, the mobile shop vehicle 100 carrying the shop D is gathered at the current position. Of the user. Then, the mobile shop vehicle 100 carrying the shop D moves to the mobile shop vehicle 100 carrying the shop B, with the user on board.

Then, when the mobile shop vehicle 100 carrying the shop D arrives at the mobile shop vehicle 100 carrying the shop B, the user is enabled to visit the shop B. Here, as illustrated in FIG. 10C, when the user moves from the mobile shop vehicle 100 carrying the shop D to the mobile shop vehicle 100 carrying the shop B, the mobile shop vehicle 100 carrying the shop B heads toward the mobile shop vehicle 100 carrying the shop C, which is the desired shop the user visits next, with the user on board. That is, the user may head toward a desired shop which is planned to be visited next, while shopping in a desired shop, for example. Then, as illustrated in FIG. 10D, when the mobile shop vehicle 100 carrying the shop B arrives at the mobile shop vehicle 100 carrying the shop C, the user is enabled to visit the shop C.

Also according to the mode of gathering together described above, a user may efficiently visit shops the user wishes to visit. Even in a case where it is difficult for a user to walk to a desired shop, the user may visit the desired shop. That is, the convenience of the user may be increased.

### Fourth Embodiment

Next, a fourth embodiment of the present disclosure will be described. The present embodiment is an example where there is competition between users regarding a desired shop for which a visit request is made by a user. Additionally, in the present embodiment, a detailed description of components and control processes substantially the same as those of the first embodiment is omitted.

In the case where a plurality of users make a request to visit a same shop in a same time slot, there is competition between the users regarding the desired shop. In such a case, the operation plan creation unit 2024 of the server device 200 may create an operation plan by prioritizing a request from an arbitrary user. For example, the operation plan creation unit 2024 may prioritize a user who made the request first. Additionally, at the time of reception of a request from the user by the user terminal 300, reception may be disabled for a shop which is already requested by another user. Alternatively, that a request is already made by another user may be displayed to urge a change of the use time.

Alternatively, the operation plan creation unit 2024 may create an operation plan in such a way that a desired shop is shared between a plurality of users who made the request. For example, the operation plan creation unit 2024 may create, an operation plan in such a way that the mobile shop vehicle 100 carrying the desired shop heads to a location which can be easily accessed by anyone of these users.

### The Other Embodiments

The embodiments described above are merely examples, and a plurality of embodiments may be combined, or a modification may be made as appropriate within the scope of the present disclosure. For example, a process which is described to be performed by one device may be divided and performed by a plurality of devices. A process which is described to be performed by different devices may be performed by one device. Which hardware component (server component) in a computer system is to achieve each function may be flexibly changed.

What is claimed is:

1. A mobile shop system comprising a plurality of mobile shop vehicles and a server device, wherein
the server device includes at least one processor configured to:
acquire, from a user who uses the mobile shop system, a visit request including a desired shop which the user wishes to visit among shops carried by the plurality of mobile shop vehicles,
acquire position information of the plurality of mobile shop vehicles and the user,
create an operation plan for the plurality of mobile shop vehicles in such a way that the user and a mobile shop vehicle carrying the desired shop are enabled to gather together at a predetermined location, based on the visit request and the position information of the plurality of mobile shop vehicles and the user, and
transmit the operation plan to the plurality of mobile shop vehicles, and
each of the plurality of mobile shop vehicles includes at least one processor configured to:
receive the operation plan transmitted by the server device, and
manage operation of a vehicle according to the operation plan that is received.

2. The mobile shop system according to claim 1, wherein the at least one processor of the server device is further configured to:
acquire a visiting order of the user visiting the desired shop's, the visiting order included in the visit request, and
create the operation plan in such a way that mobile shop vehicles carrying the desired shops are lined up at the predetermined location according to the visiting order.

3. The mobile shop system according to claim 1, wherein the at least one processor of the server device is configured to create the operation plan in such a way that the mobile shop vehicle carrying the desired shop is gathered at a current position of the user.

4. The mobile shop system according to claim 1, wherein the at least one processor of the server device is configured to create the operation plan in such a way that an arbitrary mobile shop vehicle among the plurality of mobile shop vehicles is enabled to transport the user to the mobile shop vehicle carrying the desired shop.

5. The mobile shop system according to claim 4, wherein the at least one processor-of the server device is further configured to:
acquire a visiting order of the user visiting the desired shops, the visiting order included in the visiting request, and
create the operation plan in such a way that the mobile shop vehicle carrying the desired shop that is currently visited by the user is enabled to transport the user to the mobile shop vehicle carrying the desired shop to be visited next by the user.

6. The mobile shop system according to claim 1, wherein the at least one processor of the server device is configured to acquire the visit request from a mobile terminal of the user.

7. The mobile shop system according to claim 1, wherein the plurality of mobile shop vehicles are autonomous mobile bodies configured to move autonomously according to the operation plan.

8. A control method of a mobile shop system including a plurality of mobile shop vehicles and a server device, the control method comprising:
acquiring, by the server device, a user who uses the mobile shop system, a visiting request including a desired shop which the user wishes to visit, among shops carried by the plurality of mobile shop vehicles;
acquiring, by the server device, position information of the plurality of mobile shop vehicles and the user;
creating, by the server device, an operation plan for the plurality of mobile shop vehicles in such a way that the user and a mobile shop vehicle carrying the desired shop are enabled to gather together at a predetermined location, based on the visit request and the position information of the plurality of mobile shop vehicles and the user;
transmitting, by the server device, the operation plan to the plurality of mobile shop vehicles;
receiving, by each of the plurality of mobile shop vehicles, the operation plan transmitted by the server device; and
managing, by the each of the plurality of mobile shop vehicles, operation of a vehicle according to the operation plan that is received.

9. A non-transitory computer-readable recording medium recording a program for causing a computer to execute the control method according to claim 8.
